(19) United States
(12) Patent Application Publication
(10) Pub. No.: US 2009/0250299 A1
(43) Pub. Date: Oct. 8, 2009

(54) Brake pad holder with arrangement for fine adjustment of a distance between brake pad and wheel rim

(76) Inventor: Szu-Fang Tsai, Changhua (TW)

Correspondence Address: SAM CHEN, 7F-1, 293, ROOSEVELT ROAD, SEC 3, TAIPEI, TW

(21) Appl. No.: 12/099,161

(22) Filed: Apr. 8, 2008

(51) Int. Cl. B62L 3/02

(52) U.S. Cl. 188/24.22

(57) ABSTRACT

A bicycle brake pad holder includes a hollow fastening rod comprising a head, a concave surface on the head, and an annular flange on the concave surface; a brake pad mount including a slotted channel, a convex receptor opposite the channel, a hole through the convex receptor, and a nut disposed in the hole, the nut having a projection projecting out of the hole; a brake pad removably mounted on the channel; and a bolt driven into the fastening rod to secure to the nut with the receptor urged against the concave surface and the flange put on the projection. Loosening the bolt will disengage the receptor from the concave surface to allow the receptor to move vertically and transversely relative to the flange. Hence, a fine adjustment of a distance between the brake pad and a wheel rim is effected.

### BACKGROUND OF THE INVENTION

1. Field of Invention

The invention relates to bicycle brake pad holder and more particularly to such a bicycle brake pad holder having an arrangement for effecting a fine adjustment of a distance between brake pad and wheel rim.

2. Description of Related Art

A conventional bicycle brake mounted proximate a front fork is shown in FIGS. 7 and 8. The brake comprises two identical assemblies including a substantially L-shaped brake caliper arm 50 having a substantially horizontal portion 501 with an open end secured to a brake actuation cable 500 and a substantially vertical portion 502 with an open end secured to a bolt and nut type fastener 51 having a through opening 511 disposed between two opposite side walls of the brake caliper arm 50; and a brake pad holder 52 including a fastening rod 521 inserted into the through opening 511 to secure the brake pad holder 52 to the brake caliper arm 50, and a brake pad mount 522 secured to the head of the fastening rod 521; and a brake pad 53 releasably secured onto the brake pad mount 522.

A driver may pivotably press a brake lever to pull the brake actuation cables 500 which in turn apply force to pivot the brake caliper arms 50. As a result, the brake pads 53 move to engage both sides of the wheel rim for braking as known in the art.

It is also known that an optimum distance between the brake pad 53 and the wheel rim is required for achieving a maximum braking effect by applying a minimum brake force by pressing the brake lever about a handlebar. However, the conventional bicycle brake shown above is not capable of achieving the purpose by adjustment. In detail, a driver has to use a tool to loosen the fastener 51. Next, pivot the brake pad holder 50 about its bending point (see FIG. 7). However, the position of the brake pad 53 is not adapted to adjust since it is fixedly secured to the brake pad mount 522 which is again secured to the fastening rod 521.

There have been numerous suggestions in prior patents for brake pad holder. For example, U.S. Pat. No. 5,074,175 discloses a bicycle brake adjusting tool. Thus, continuing improvements in the exploitation of brake pad holder with a brake pad adjustment arrangement are constantly being sought.

### SUMMARY OF THE INVENTION

It is therefore one object of the invention to provide a bicycle brake pad holder having an arrangement for effecting fine adjustment of a distance between a brake pad and a wheel rim.

The above and other objects, features and advantages of the invention will become apparent from the following detailed description taken with the accompanying drawings.

### BRIEF DESCRIPTION OF THE DRAWINGS

FIG. 1 is a schematic front view of a bicycle brake mounted proximate a front fork according to the invention;

FIG. 2 is a perspective view of the bicycle brake of FIG. 1;

FIG. 3 is an exploded view of the bicycle brake of FIG. 1;

FIG. 4 is a top view of the bicycle brake of FIG. 2 with the brake pad holder being shown in section;

FIG. 5 is a top view of the bicycle brake of FIG. 2;

FIG. 6 is a view similar to FIG. 4 showing an adjustment operation of the brake pad holder of FIG. 2;

FIG. 7 is a schematic front view of a conventional bicycle brake mounted proximate a front fork; and

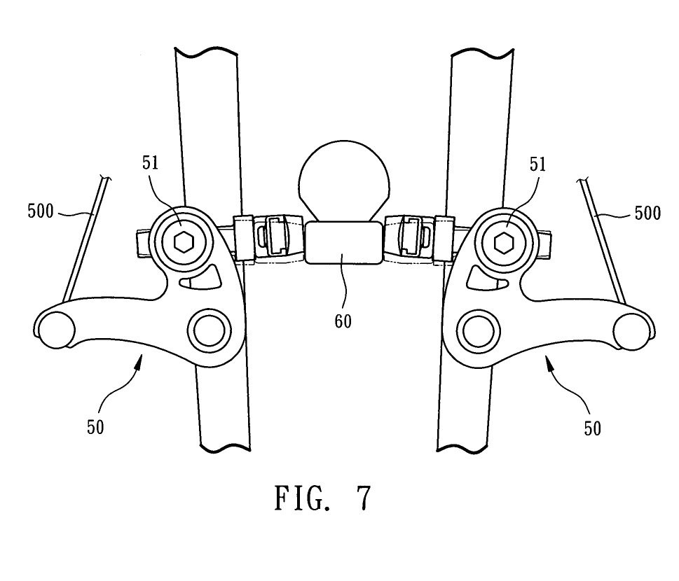

FIG. 8 is an exploded perspective view of the conventional bicycle brake.

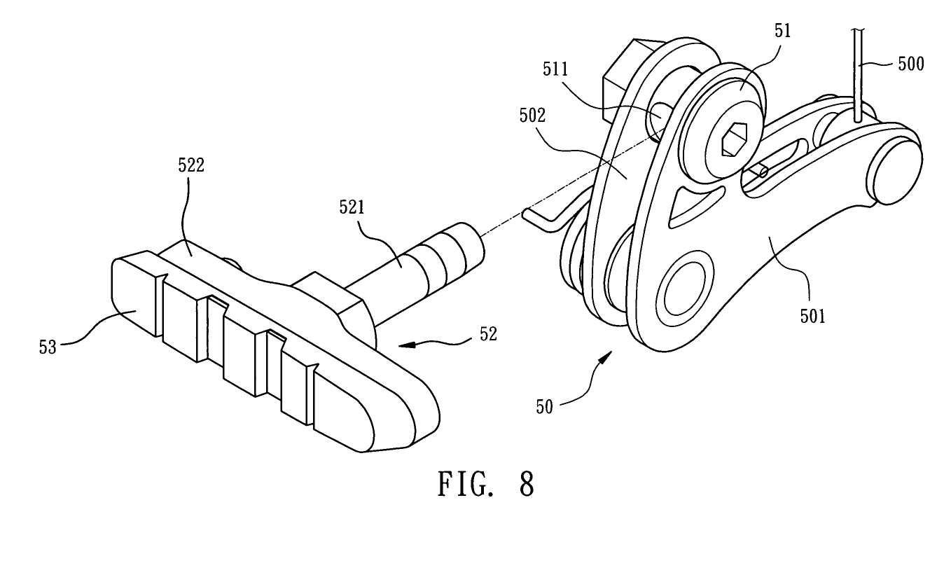

### DETAILED DESCRIPTION OF THE INVENTION

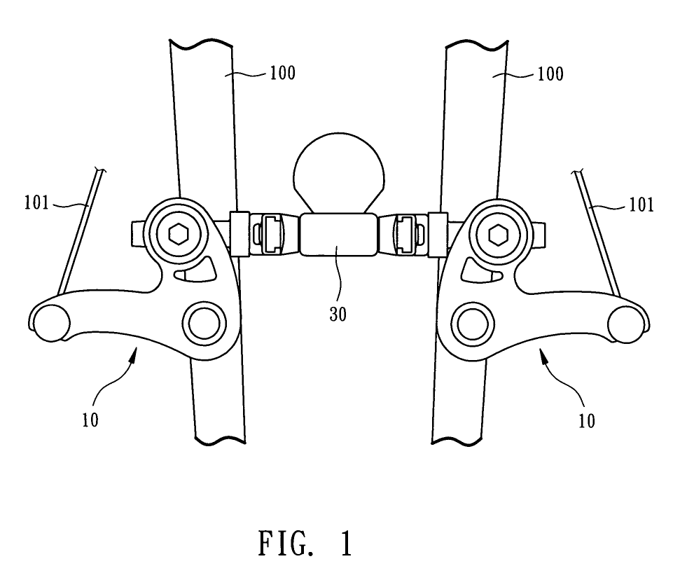

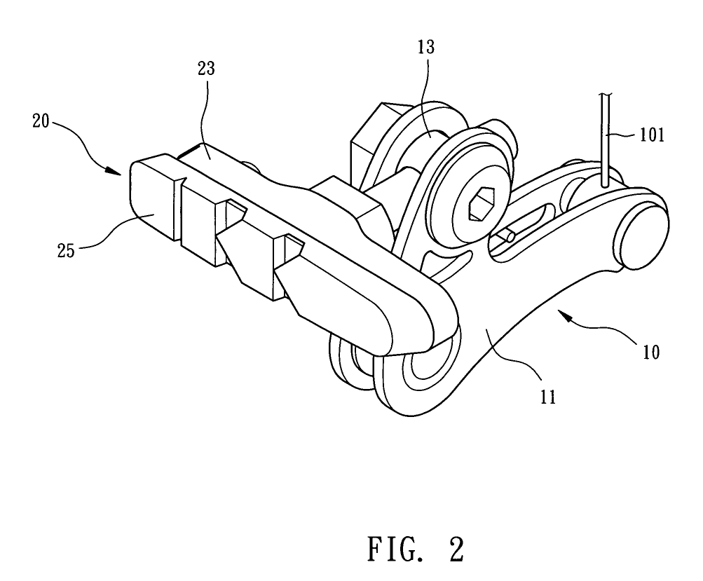

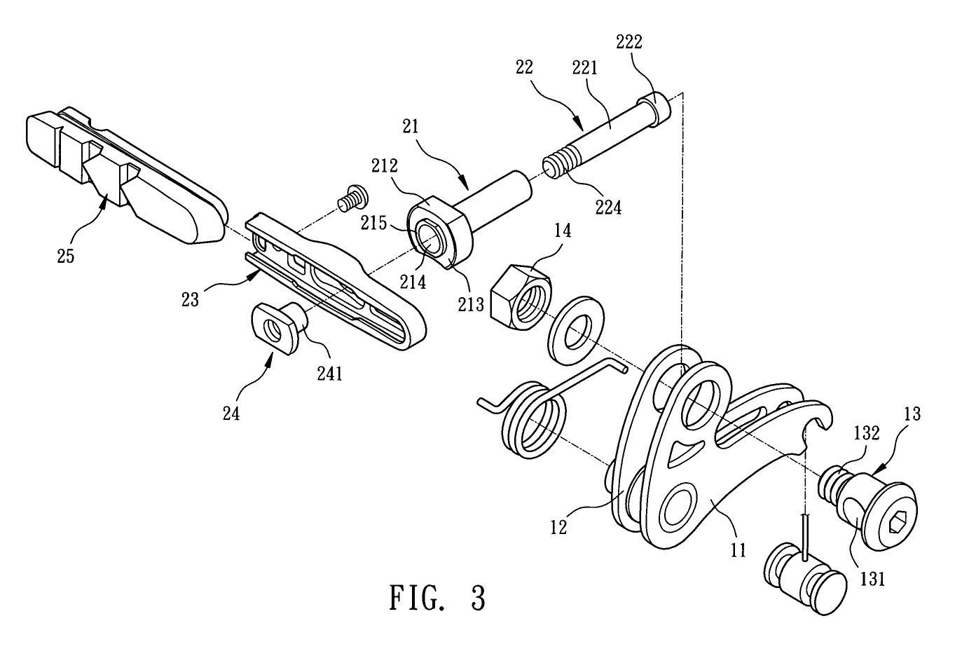

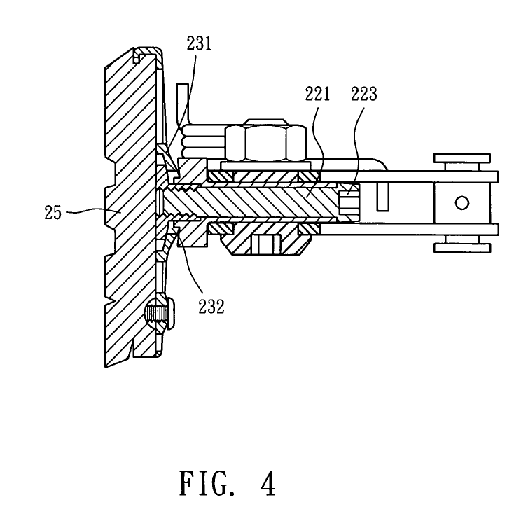

Referring to FIGS. 1 to 6, a bicycle brake in accordance with a preferred embodiment of the invention is shown. While the bicycle brake is mounted proximate a front fork 100 in this embodiment, it can also be mounted proximate a rear stay without departing from the scope of the invention.

The bicycle brake comprises two identical assemblies including a substantially L-shaped brake caliper arm 10 having a substantially horizontal portion 11 with an open end secured to a brake actuation cable 101 and a substantially vertical portion 12 with an open end secured to a fastener 13 including a through opening 131 disposed between two opposite side walls of the brake caliper arm 10, and a threaded shank 132 adapted to secured to a nut 14; and a brake pad holder 20 including a fastening rod 21, a bolt 22, a brake pad mount 23 having a slotted channel (not numbered) on which is removably mounted a brake pad 25, and a nut 24.

The fastening rod 21 comprises a shank 211, a bore 214 open to both ends, a head 212, a concave surface 213 on the head 212 facing the brake pad mount 23, and an annular flange 215 on the mouth of the bore 214 also facing the brake pad mount 23. The bolt 22 comprises a shank 221 without threads, a threaded end portion 224, a head 222, and a recess (e.g., a six-point recess) 223 in the head 222. The provision of the recess 223 aims to facilitate a tightening or loosening of the bolt 22. The brake pad mount 23 further comprises a convex receptor 231 opposite its channel facing the fastening rod 21. The receptor 231 has a central through hole 232.

In assembly, insert the fastener 13 through two end openings (not numbered) of the substantially vertical portion 12 of the brake caliper arm 10 with the through opening 131 disposed between the opposite side walls of the brake caliper arm 10. Next, insert the fastening rod 21 through the through opening 131 until being stopped. Next, secure the nut 14 to the threaded shank 132 to fasten the fastening rod 21. Next, dispose the nut 24 in the receptor 231 of the brake pad mount 23 with a projection 241 of the nut 24 projecting out of the through hole 232. Next, slide the brake pad 25 into place in the channel of the brake pad mount 23 and threadedly secure the brake pad 25 and the brake pad mount 23 together. Next put the receptor 231 of the brake pad mount 23 onto the concave surface 213 so as to receive the flange 215 in the through hole 232 and put the flange 215 on the projection 241 of the nut 24. Finally, insert the bolt 22 into the bore 214 of the fastening rod 21 to secure the threaded end portion 224 to the nut 24.

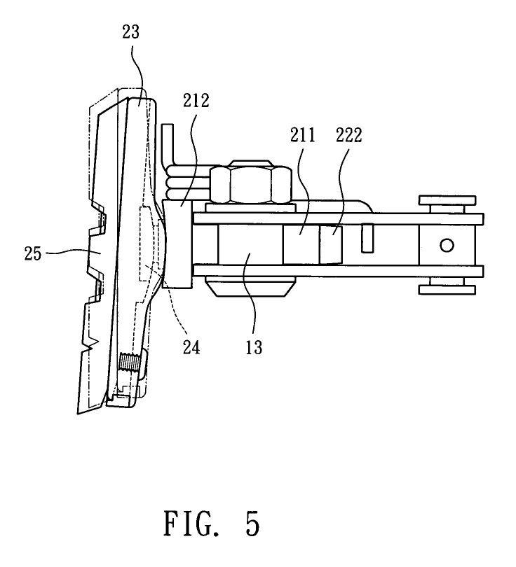

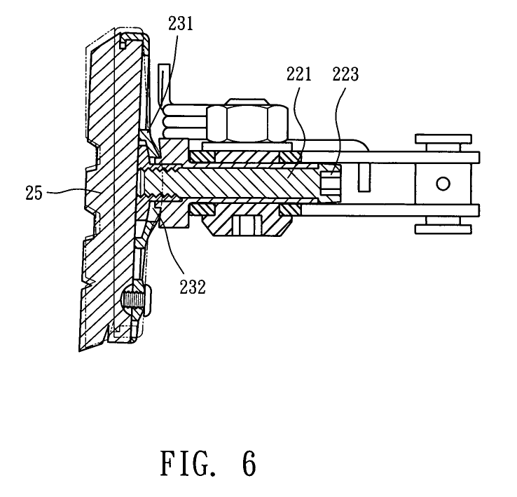

A transverse adjustment of the brake pad holder 20 of the invention will be described in detail below. First, loosen the bolt 22 to disengage the receptor 231 of the brake pad mount 23 from the concave surface 213. Thus, the receptor 231 of the brake pad mount 23 is adapted to axially slide relative to the flange 215, i.e., fine adjustment of the transverse position of the brake pad 25 as indicated by dotted lines in FIGS. 5 and 6. Moreover, the flange 215 is loosened in the through hole 232 so that a vertical adjustment of the brake pad holder 20 (i.e., the brake pad 25) is made possible.

While the invention herein disclosed has been described by means of specific embodiments, numerous modifications and variations could be made thereto by those skilled in the art without departing from the scope and spirit of the invention set forth in the claims.

What is claimed is:

1. A brake pad holder secured by a brake caliper arm, comprising:
a hollow fastening rod comprising a head, a concave surface on the head, and an annular flange on the concave surface;
a brake pad mount including a slotted channel, a convex receptor opposite the channel, a hole through the convex receptor, and a nut disposed in the hole, the nut having a projection projecting out of the hole;
a brake pad removably mounted on the channel; and
a bolt driven into the fastening rod to secure to the nut with the receptor urged against the concave surface and the flange put on the projection;
whereby loosening the bolt will disengage the receptor from the concave surface to allow the receptor to move vertically and transversely relative to the flange.

2. The brake pad holder of claim 1, wherein the bolt comprises a recess of a predetermined shape in its head.
